(19) United States
(12) Patent Application Publication
(10) Pub. No.: US 2013/0299154 A1
(43) Pub. Date: Nov. 14, 2013

(54) THERMAL MODULE AND MANUFACTURING METHOD THEREOF

(71) Applicants: Sheng-Huang Lin, New Taipei City (TW); Chi-Ming Lee, New Taipei City (TW); Jin-Hsun Liu, Sinjhuang City (TW)

(72) Inventors: Sheng-Huang Lin, New Taipei City (TW); Chi-Ming Lee, New Taipei City (TW); Jin-Hsun Liu, Sinjhuang City (TW)

(21) Appl. No.: 13/469,664

(22) Filed: May 11, 2012

(51) Int. Cl. F28F 7/00; B23P 15/26

(52) U.S. Cl. 165/185; 29/890.03

(57) ABSTRACT

A thermal module and a manufacturing method thereof. The thermal module includes a radiating fin assembly and a base seat. The radiating fin assembly has at least one folded edge on one side. The folded edge has at least one connection section. The base seat has at least one fixing section corresponding to the connection section. The fixing section is latched with the folded edge. A pressure is applied to the fixing section to plastically deform the fixing section and press the fixing section against the folded edge so as to securely connect the radiating fin assembly with the base seat. The thermal module can be assembled without welding so that the working time is shortened and the manufacturing cost is lowered.

### BACKGROUND OF THE INVENTION

1. Field of the Invention

The present invention relates to a thermal module and a manufacturing method thereof. The thermal module includes a radiating fin assembly and a base seat. The base seat can be plastically deformed by means of applying a pressure to the base seat so as to fast and securely connect the radiating fin assembly with the base seat. The thermal module can be assembled without welding so that the working time is shortened and the manufacturing cost is lowered.

2. Description of the Related Art

The existent heat dissipation device such as a thermal module is composed of multiple heat dissipation components, which are cooperatively assembled with each other. The heat dissipation components are heat pipe, heat sink, heat dissipation base seat, etc. These heat dissipation components are mainly securely connected with each other by means of welding. However, with respect to an aluminum-made heat dissipation component, the welding operation necessitates a special welding process. Therefore, the processing cost is increased.

In addition, some manufacturers use fixing members such as screws to fixedly connect the heat dissipation components. However, only some of the heat dissipation components, (such as the radiating fin assembly and heat dissipation base seat), can be fixedly locked with screws, while the heat pipe cannot be directly fixed by means of screws.

Moreover, some other manufacturers fixedly connect the radiating fin assembly with the base seat in a press-fit manner. In the press-fit process, the radiating fins and the base seat are likely to crack. This will increase the ratio of defective products. According to the above, the conventional thermal module has the following shortcomings:

1. The cost is higher.

2. The working time is longer.

3. The ratio of defective products is higher.

### SUMMARY OF THE INVENTION

A primary object of the present invention is to provide a thermal module, which can be quickly assembled to lower manufacturing cost.

A further object of the present invention is to provide a manufacturing method of a thermal module, by means of which the thermal module can be quickly assembled to lower manufacturing cost.

To achieve the above and other objects, the thermal module of the present invention includes a radiating fin assembly and a base seat.

The radiating fin assembly has at least one folded edge on one side. The folded edge has at least one connection section. The base seat has at least one fixing section corresponding to the connection section. The fixing section can be latched with the folded edge.

The manufacturing method of the thermal module of the present invention includes steps of: providing a radiating fin assembly composed of multiple radiating fins and a base seat having at least one fixing section on one side;

forming a folded edge and at least one connection section on one side of the radiating fin assembly; and plug-in connecting the connection section of the radiating fin assembly with the corresponding fixing section of the base seat and applying a pressure to the fixing section by means of a tool to press the fixing section against the folded edge of the radiating fin assembly.

According to the thermal module and the manufacturing method of the thermal module of the present invention, the thermal module can be assembled without welding so that the assembling time of the thermal module is greatly shortened. Therefore, the manufacturing cost for the thermal module is lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the thermal module of the present invention; FIG. 2 is a perspective assembled view of the first embodiment of the thermal module of the present invention;

FIG. 3 is a sectional assembled view of the first embodiment of the thermal module of the present invention;

FIG. 4 is a sectional assembled view of a second embodiment of the thermal module of the present invention;

FIG. 5 is a sectional assembled view of a third embodiment of the thermal module of the present invention;

FIG. 6 is a perspective exploded view of a fourth embodiment of the thermal module of the present invention;

FIG. 7 is a perspective view of the radiating fin assembly of a fifth embodiment of the thermal module of the present invention; and

FIG. 8 is a flow chart of the manufacturing method of the thermal module of the present invention.

### DETAILED DESCRIPTION OF THE PREFERRED EMBODIMENTS

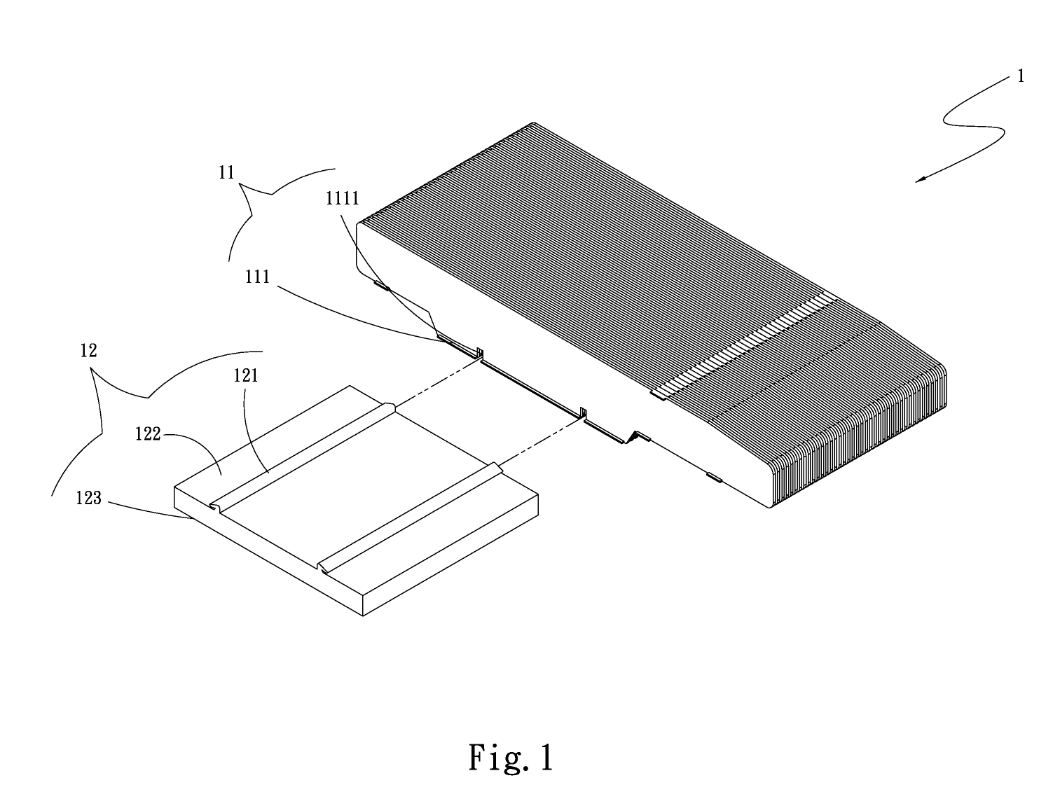

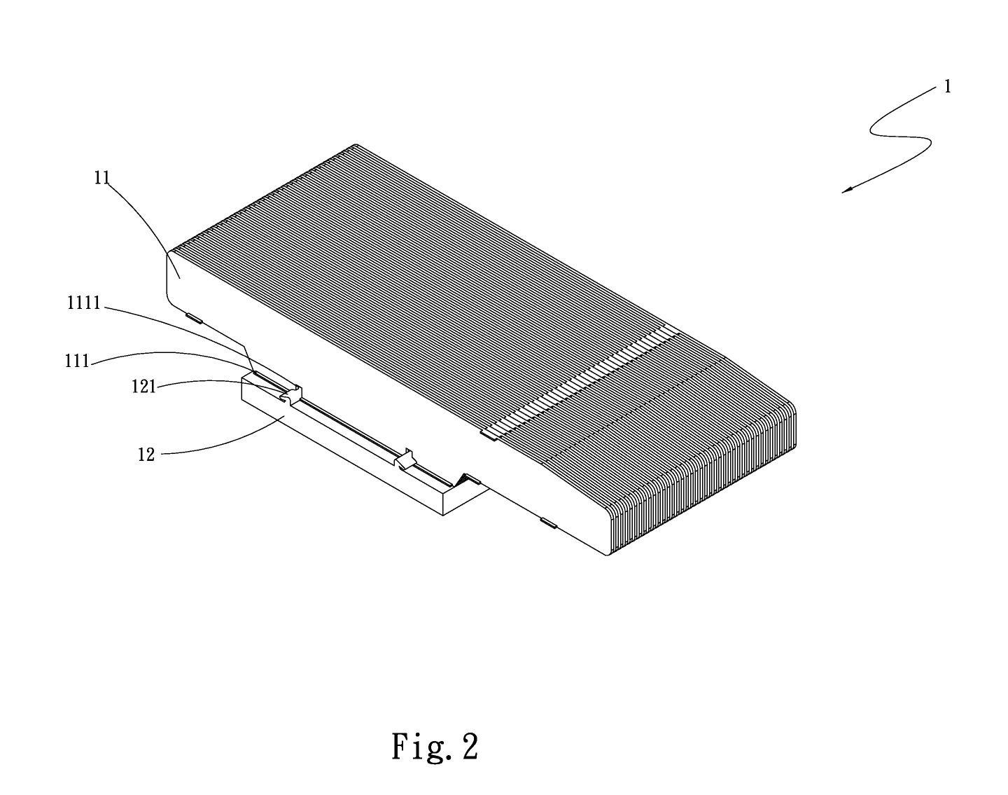

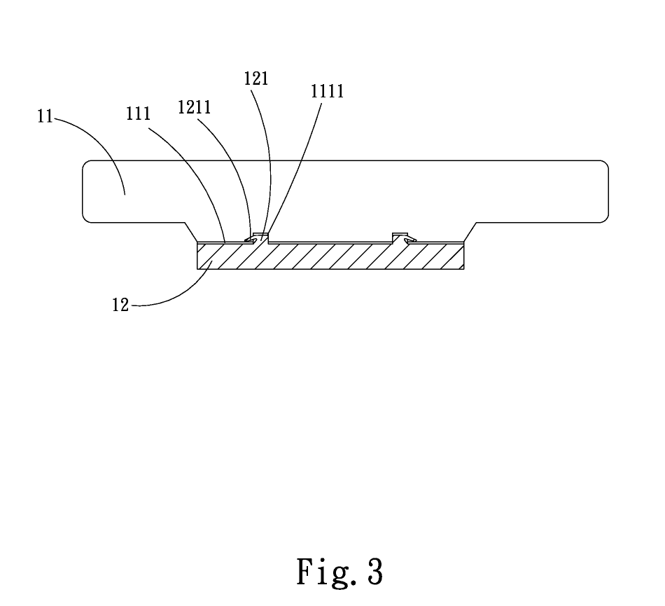

Please refer to FIGS. 1, 2 and 3. FIG. 1 is a perspective exploded view of a first embodiment of the thermal module of the present invention. FIG. 2 is a perspective assembled view of the first embodiment of the thermal module of the present invention. FIG. 3 is a sectional assembled view of the first embodiment of the thermal module of the present invention. According to the first embodiment, the thermal module 1 of the present invention includes a radiating fin assembly 11 and a base seat 12.

The radiating fin assembly 11 has at least one folded edge 111 on one side. The folded edge 111 has at least one connection section 1111.

The base seat 12 has at least one fixing section 121 corresponding to the connection section 1111. The fixing section 121 can be latched with the folded edge 111.

The base seat 12 has a first side 122 and a second side 123. The fixing section 121 is disposed on the first side 122. The fixing section 121 has at least one first extension end 1211. The first extension end 1211 extends from a free end of the fixing section 121 in a direction toward the base seat 12. The first extension end 1211 is pressed against and latched with the folded edge 111.

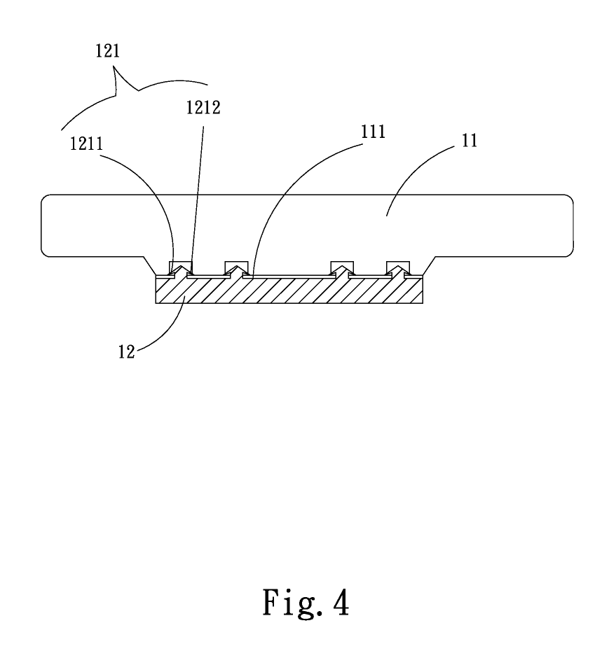

Please now refer to FIG. 4, which is a sectional assembled view of a second embodiment of the thermal module of the present invention. The second embodiment is partially identical to the first embodiment in structure and thus will not be repeatedly described hereinafter. The second embodiment is different from the first embodiment in that the fixing section 121 further has a second extension end 1212. The first and second extension ends 1211, 1212 respectively extend from the free end of the fixing section 121 in a direction toward the base seat 12. When a pressure is applied to the first and second extension ends 1211, 1212 to plastically deform the first and second extension ends 1211, 1212, the first and second extension ends 1211, 1212 are respectively bent and pressed against the folded edges 111 of the radiating fin assembly 11.

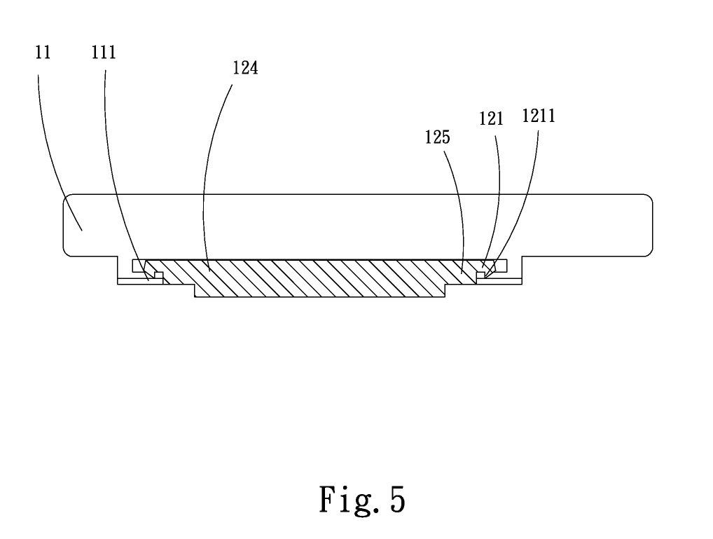

Please now refer to FIG. 5, which is a sectional assembled view of a third embodiment of the thermal module of the present invention. The second embodiment is partially identical to the first embodiment in structure and thus will not be repeatedly described hereinafter. The third embodiment is different from the first embodiment in that the base seat 12 further has a first end 124 and a second end 125. The first extension ends 1211 of the fixing sections 121 are respectively disposed at the first and second ends 124, 125. When a pressure is applied to the first extension ends 1211 to plastically deform the first extension ends 1211, the first extension ends 1211 are bent and engaged with the folded edges 111 of the radiating fin assembly 11.

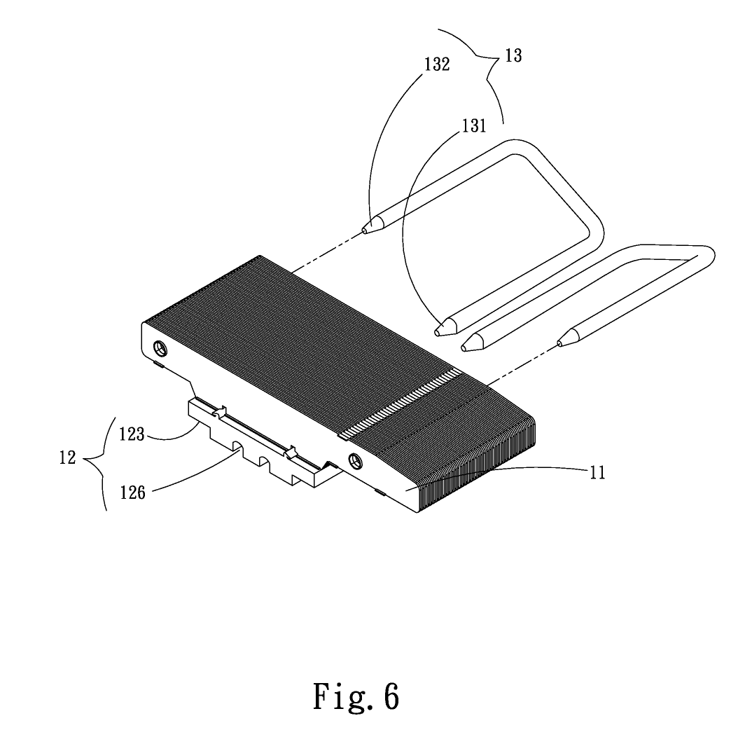

Please now refer to FIG. 6, which is a perspective exploded view of a fourth embodiment of the thermal module of the present invention. The fourth embodiment is partially identical to the first embodiment in structure and thus will not be repeatedly described hereinafter. The fourth embodiment is different from the first embodiment in that the thermal module 1 further includes at least one heat pipe 13 and a groove 126. The heat pipe 13 has a heat absorption end 131 and a heat dissipation end 132. The groove 126 is formed on the second side 123 of the base seat 12. The heat absorption end 131 is received in the groove 126. The heat dissipation end 132 passes through the radiating fin assembly 11.

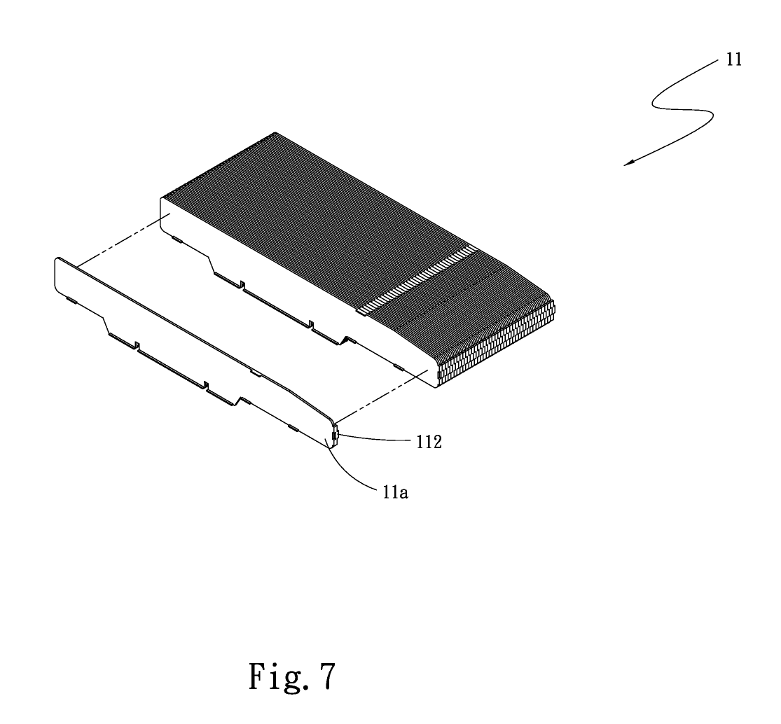

Please now refer to FIG. 7, which is a perspective view of the radiating fin assembly of a fifth embodiment of the thermal module of the present invention. The fifth embodiment is partially identical to the first embodiment in structure and thus will not be repeatedly described hereinafter. The fifth embodiment is different from the first embodiment in that the radiating fin assembly 11 is composed of multiple stacked up radiating fins 11a. Two sides of each radiating fin 11a are respectively formed with two latch sections 112.

By means of the latch sections 112, the radiating fins 11a can be latched and assembled with each other.

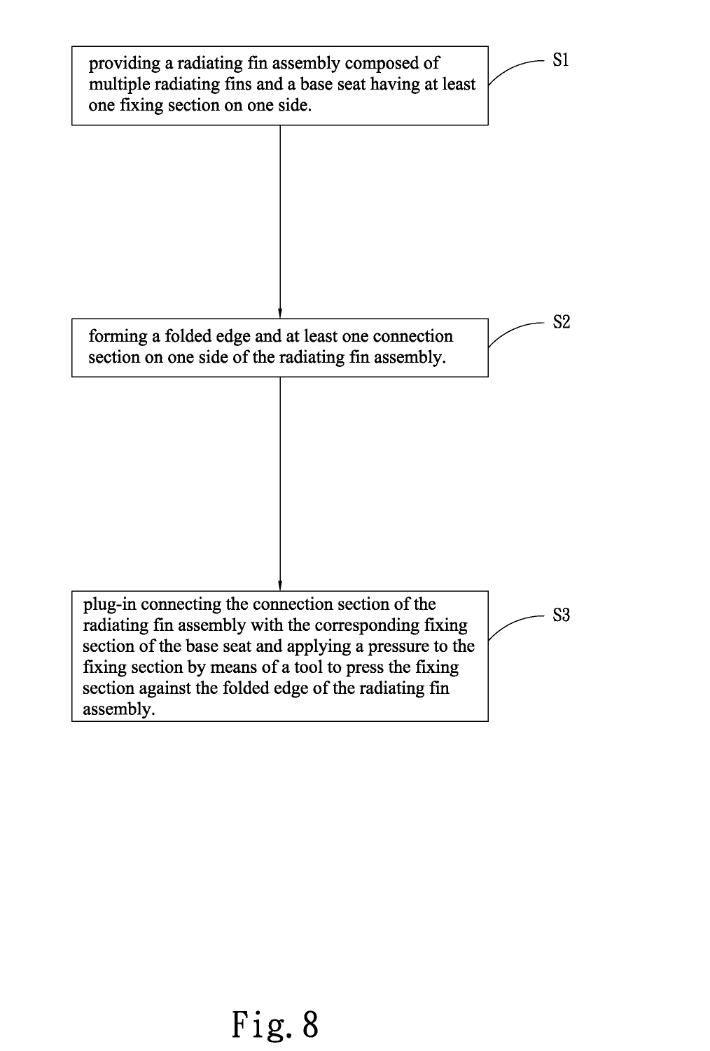

Please now refer to FIG. 8, which is a flow chart of the manufacturing method of the thermal module of the present invention. Also referring to FIGS. 1 to 7, the manufacturing method of the thermal module of the present invention includes steps of:

S1: providing a radiating fin assembly composed of multiple radiating fins and a base seat having at least one fixing section on one side, a radiating fin assembly 11 composed of multiple stacked up radiating fins 11a being provided, also, a base seat 12 having at least one fixing section 121 on one side as shown in FIG. 1 being provided;

S2: forming a folded edge and at least one connection section on one side of the radiating fin assembly, a folded edge 111 being formed on at least one side of each radiating fin 11a of the radiating fin assembly 11, at least one connection section 1111 being formed on the folded edge 111 corresponding to the fixing section 121 of the base seat 12; and

S3: plug-in connecting the connection section of the radiating fin assembly with the corresponding fixing section of the base seat and applying a pressure to the fixing section by means of a tool to press the fixing section against the folded edge of the radiating fin assembly, the radiating fin assembly 11 being correspondingly positioned on one side of the base seat 12, which side has the fixing section 121, then the connection section 1111 of the radiating fin assembly 11 being correspondingly assembled with the fixing section 121 of the base seat 12, then a pressure being applied to the fixing section 121 by means of a tool to plastically deform the fixing section 121 and press the fixing section 121 against the folded edge 111 so as to connect the radiating fin assembly 11 with the base seat 12.

In this embodiment, the tool is, but not limited to, a press for illustration purposes only.

The pressure is applied to the fixing section 121 by means of mechanical processing to plastically deform the fixing section 121. In this embodiment, the mechanical processing is, but not limited to, press processing for illustration purposes only.

According to the structure of the thermal module of the present invention and the manufacturing method thereof, the thermal module can be assembled without welding so that the assembling time of the thermal module is shortened. Therefore, the manufacturing cost for the thermal module is greatly lowered.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A thermal module comprising:
a radiating fin assembly, the radiating fin assembly having at least one folded edge on one side, the folded edge having at least one connection section; and
a base seat having at least one fixing section corresponding to the connection section, the fixing section being latched with and pressed against the folded edge.

2. The thermal module as claimed in claim 1, wherein the base seat has a first side and a second side, the fixing section being disposed on the first side, the fixing section having at least one first extension end, the first extension end being pressed against and latched with the folded edge.

3. The thermal module as claimed in claim 2, wherein the fixing section further has a second extension end, the first and second extension ends respectively extending from a free end of the fixing section in a direction toward the base seat.

4. The thermal module as claimed in claim 2, wherein the base seat further has a first end and a second end, the first extension ends of the fixing sections being respectively disposed at the first and second ends.

5. The thermal module as claimed in claim 2, further comprising at least one heat pipe and a groove, the heat pipe having a heat absorption end and a heat dissipation end, the groove being formed on the second side of the base seat, the heat absorption end being received in the groove, the heat dissipation end passing through the radiating fin assembly.

6. The thermal module as claimed in claim 1, wherein the radiating fin assembly is composed of multiple stacked up radiating fins, two sides of each radiating fin being respectively formed with two latch sections.

7. A manufacturing method of a thermal module, comprising steps of:
providing a radiating fin assembly composed of multiple radiating fins and a base seat having at least one fixing section on one side;
forming a folded edge and at least one connection section on one side of the radiating fin assembly; and
plug-in connecting the connection section of the radiating fin assembly with the corresponding fixing section of the base seat and applying a pressure to the fixing section by means of a tool to press the fixing section against the folded edge of the radiating fin assembly.

8. The manufacturing method of the thermal module as claimed in claim 7, wherein the pressure is applied to the fixing section by means of mechanical processing to plastically deform the fixing section.

9. The manufacturing method of the thermal module as claimed in claim 8, wherein the mechanical processing is press processing.

10. The manufacturing method of the thermal module as claimed in claim 7, wherein the tool is a press.
